(19) United States
(12) Patent Application Publication
(10) Pub. No.: US 2008/0043019 A1
(43) Pub. Date: Feb. 21, 2008

(54) Method And Apparatus For Transforming Object Vertices During Rendering Of Graphical Objects For Display

(76) Inventors: Graham Sellers, Toronto (CA); Eric Krowicki, Brampton (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/465,017

(22) Filed: Aug. 16, 2006

(51) Int. Cl. G06T 15/10

(52) U.S. Cl. 345/427

(57) ABSTRACT

A method of transforming object vertices during rendering of graphical objects for display comprises multiplying each object vertex in object space that is to be transformed, by a product matrix. The product matrix is the product of a model-view matrix and a projection matrix. As a result, each object vertex is transformed from object space to clip space via a single multiplication operation.

### FIELD OF THE INVENTION

The present invention relates generally to graphics applications and in particular to a method and apparatus for transforming object vertices during rendering of graphical objects for display.

### BACKGROUND OF THE INVENTION

OpenGL is an industry standard graphics application programming interface (API) for two-dimensional (2D) and three-dimensional (3D) graphics applications. In general, the OpenGL API processes graphics data representing objects to be rendered, that is received from a host application, and renders graphical objects on a display device for viewing by the user. The graphics data for each object comprises an array of 3D coordinates and associated data, commonly referred to as vertices. The object vertices are represented as four-element homogenous vectors [x, y, z, w], where x, y, and z are the vertex coordinates in 3D space and w is one (1). When the object vertices are received, the OpenGL API transforms the object vertices and constructs graphics primitives by grouping sets of the object vertices together to form points, lines, triangles and polygons. The constructed graphics primitives are then used to render the graphical object on the display device.

Techniques to process object vertices are well documented. For example, U.S. Pat. No. 6,552,733 to Taylor et al. discloses a configurable vertex blending circuit that allows both morphing and skinning operations to be supported in dedicated hardware. The vertex blending circuit includes a matrix array that is used for storing the matrices associated with the various portions of vertex blending operations. Vertex data is stored in an input vertex buffer that includes multiple position buffers such that the multiple positions associated with morphing operations can be stored. The single position typically associated with skinning operations can be stored in one of the position buffers. The input vertex buffer further stores blending weights associated with the various component operations that are included in the overall vertex blending operation. An arithmetic unit, which is configured and controlled by a transform controller, performs the calculations required for each of a plurality of component operations included in the overall vertex blending operation. The results of each of these component operations are then combined to produce a blended vertex.

U.S. Pat. No. 6,567,084 to Mang et al. discloses a lighting effect computation block and method. The lighting effect computation block separates lighting effect calculations for video graphics primitives into a number of simpler calculations that are performed in parallel but accumulated in an order-dependent manner. Each of the individual calculations is managed by a separate thread controller. Lighting effect calculations for a vertex of a primitive may be performed using a single parent light thread controller and a number of sub-light thread controllers. Each thread controller manages a thread of operation codes related to determination of the lighting parameters for the particular vertex. The thread controllers submit operation codes to an arbitration module based on the expected latency and interdependency between the various operation codes. The arbitration module determines which operation code is executed during a particular cycle, and provides that operation code to a computation engine. The computation engine performs calculations based on the operation code and stores results either in memory or in an accumulation buffer corresponding to the particular vertex lighting effect block. In order to ensure that the order-dependent operations are properly performed, each of the sub-light thread controllers determines whether or not the accumulation operations for the preceding threads have been initiated before it submits its own operation code to the arbitration module.

U.S. Pat. No. 6,573,894 to Idaszak et al. discloses a method whereby image data is converted to non-planar image data for display on a non-planar display, using a planar image graphics computer system, such as an OpenGL RTM system. During the method, a transformation matrix is obtained from the planar image graphics computer system. A plurality of vertices of the image data are multiplied by the obtained transformation matrix, to produce transformed image data. The transformed image data is non-planar distortion corrected to produce non-planar image data. A pass-through transformation matrix, such as an identity matrix, is provided to the planar image graphics computer system. The non-planar image data is then input to the planar image graphics computer system for further processing. The non-planar image data which is processed by the planar image graphics computer system is then displayed on the non-planar display.

U.S. Pat. No. 6,700,586 to Demers discloses a graphics system including a custom graphics and audio processor that produces 2D and 3D graphics and surround sound. An additional matrix multiplication computation unit is connected in cascade with a model-view matrix computation unit and supports a piecewise linear version of skinning for skeletal animation modeling. A normaliser connected between the cascaded matrix multiplication computation units provides normalization to avoid distorted visualization. The additional matrix multiplication computation unit can be used for applications other than skeletal animation modeling (e.g., environment mapping).

U.S. Pat. No. 6,731,303 to Marino discloses a graphics system including an input for receiving graphics data. The graphics data includes position coordinates and a depth coordinate for an object. An output is included for transmitting processed graphics data. The graphics system also contains processing elements that generate processed graphics data. One of the processing elements is connected to the input and another of the processing elements is connected to the output. A selected processing element receives the position coordinates and the depth coordinate, inverts the depth coordinate, and multiplies the position coordinates by the inverted depth coordinate.

U.S. Pat. No. 6,894,687 to Kilgard et al. discloses a system, method and article of manufacture for aliasing vertex attributes during vertex processing. Initially, a plurality of identifiers is mapped to one of a plurality of parameters associated with vertex data. Thereafter, the vertex data is processed by calling the parameters utilizing a vertex program capable of referencing the parameters using the identifiers.

U.S. Patent Application Publication No. 2003/0009748 to Glanville et al. discloses a system for improving performance during graphics processing and involves application-programmable vertex processing. A central processing unit (CPU) includes an operating system for executing code segments capable of performing graphics processing on the CPU. Associated with the CPU is a graphics application specific integrated circuit (ASIC) including a hardware-implemented graphics pipeline capable of performing graphics processing in accordance with a graphics processing standard. Software written in accordance with the graphics processing standard is adapted for directing the graphics ASIC to perform the graphics processing. An extension to the software identifies a first portion of the graphics processing to be performed on the graphics ASIC and a second portion of the graphics processing to be performed on the CPU. The second portion of the graphics processing includes application-programmable vertex processing incalculable by the graphics ASIC. A compiler compiles the software used to execute the first portion of the graphics processing and the second portion of the graphics processing in accordance with the extension.

U.S. Patent Application Publication No. 2004/0125103 to Kaufman et al. discloses an apparatus and method for real-time volume processing and universal three-dimensional rendering. The apparatus includes three-dimensional (3D) memory units, a pixel bus for providing global horizontal communication, rendering pipelines, a geometry bus, and a control unit. A block processor with a circular ray integration pipeline processes voxel data and ray data. Rays are generally processed in image order thus permitting flexibility (e.g., perspective projection, global illumination).

U.S. Patent Application Publication No. 2005/0143654 to Zuiderveld et al. discloses systems and methods for visualizing 3D volumetric data comprising voxels using different segmentation regions. A segmentation mask vector is associated with each voxel and defines the segmentation region to which that voxel belongs. During visualization, segmentation masks are interpolated to obtain a vector of segmentation mask weights. For each sample point, a vector of visualization values is multiplied by a vector of segmentation mask weights to produce a composite fragment value. The fragment values are combined into pixel values using compositing. The computational efficiency of commodity programmable video cards is leveraged to determine subsampled partial contribution weights of multiple segmented data regions to allow correct per-fragment combination of segment specific characteristics such as color and opacity, which is suitable for volume rendering.

Although the above references disclose vertex processing techniques, they fail to address computation issues that arise during transformation of the object vertices. When objects to be rendered for display are created, the vertices defining the objects are typically in a model or object coordinate system, commonly referred to as object space. In order to render the graphical objects for display, the object vertices in object space must be projected or mapped to a window coordinate system, commonly referred to as screen space.

Projecting the object vertices from object space to screen space typically requires a series of matrix operations. FIG. 1 shows the operations that are performed to transform object vertices in object space to object vertices in screen space in an OpenGL graphics pipeline. As can be seen, during the vertex transformation process, each object vertex {Vₒ} in object space 110 is transformed to an object vertex {Vₑ} in eye space 120 by multiplying each object vertex {Vₒ} by a model-view matrix [Mₘᵥ] according to:

$$\{ {V}_{e} \} = [ {M}_{mv} ] * \{ {V}_{o} \} \\ or \\ [ \begin{matrix}{e}_{0} \\ {e}_{1} \\ {e}_{2} \\ {e}_{3}\end{matrix} ] = [ \begin{matrix}{mv}_{00} & {mv}_{10} & {mv}_{20} & {mv}_{30} \\ {mv}_{01} & {mv}_{11} & {mv}_{21} & {mv}_{31} \\ {mv}_{02} & {mv}_{12} & {mv}_{22} & {mv}_{32} \\ {mv}_{03} & {mv}_{13} & {mv}_{23} & {mv}_{33}\end{matrix} ] * [ \begin{matrix}{o}_{0} \\ {o}_{1} \\ {o}_{2} \\ {o}_{3}\end{matrix} ] \qquad ( 1 )$$

Each object vertex {Vₑ} in eye space 120 is then transformed to an object vertex {V_{c}} in clip space by multiplying each object vertex {Vₑ} by a projection matrix [Mₚ] according to:

$$\{ {V}_{c} \} = [ {M}_{p} ] * \{ {V}_{e} \} \\ or \\ [ \begin{matrix}{c}_{0} \\ {c}_{1} \\ {c}_{2} \\ {c}_{3}\end{matrix} ] = [ \begin{matrix}{p}_{00} & {p}_{10} & {p}_{20} & {p}_{30} \\ {p}_{01} & {p}_{11} & {p}_{21} & {p}_{31} \\ {p}_{02} & {p}_{12} & {p}_{22} & {p}_{32} \\ {p}_{03} & {p}_{13} & {p}_{23} & {p}_{33}\end{matrix} ] * [ \begin{matrix}{e}_{0} \\ {e}_{1} \\ {e}_{2} \\ {e}_{3}\end{matrix} ] \qquad ( 2 )$$

Once the object vertices are clip space 130, the object vertices {V_{c}} are transformed to normalized device coordinate (NDC) space 140 and then to screen space 150.

As will be appreciated, transforming object vertices in object space to object vertices in clip space is computationally expensive as it requires at least two matrix-vector multiplications per object vertex. Accordingly improvements are desired.

It is therefore an object of the present invention to provide a novel method and apparatus for transforming object vertices during rendering of graphical objects for display.

### SUMMARY OF THE INVENTION

Accordingly, in one aspect there is provided a method of transforming object vertices during rendering of graphical objects for display comprising:

multiplying each object vertex in object space that is to be transformed, by a product matrix, said product matrix being the product of a model-view matrix and a projection matrix thereby to transform each object vertex from object space to clip space via a single multiplication operation.

In one embodiment, prior to the multiplying, state information is checked to determine if the state information signifies that the product matrix is not to be used. Following the check, if the product matrix is to be used, the multiplying is performed. If the product matrix is not to be used, each object vertex in object space is multiplied by the model-view matrix to transform each object vertex to eye space and each object vertex in eye space is multiplied by the projection matrix to transform each object vertex to clip space. At least one flag is set if the product matrix is not to be used. The at least one flag is set when at least one of the model-view matrix and the projection matrix has changed and/or if at least one selected rasterization feature has been enabled.

According to another aspect there is provided a computer readable medium embodying a computer program for transforming object vertices during rendering of graphical objects for display, said computer program comprising:

computer program code for multiplying each object vertex in object space that is to be transformed, by a product matrix, said product matrix being the product of a model-view matrix and a projection matrix thereby to transform each object vertex from object space to clip space via a single multiplication operation.

According to yet another aspect there is provided a rasterization engine transforming object vertices during rendering of graphical objects for display comprising:

matrix memory storing a model-view matrix, a projection matrix and a product matrix, said product matrix being the product of said model-view and projection matrices;

state information memory; and

a graphics processor multiplying each object vertex by said product matrix to transform each object vertex from object space to clip space in a single multiplication operation.

By transforming object vertices in object space to object vertices in clip space via a single multiplication operation in-between changes to the model-view and projection matrices and when selected features of the rasterization engine are not enabled, object vertex transformations can be carried out quickly and readily thereby significantly reducing computational load.

### BRIEF DESCRIPTION OF THE DRAWINGS

An embodiment will now be described more fully with reference to the accompanying drawings in which:

FIG. 1 shows a conventional OpenGL graphics pipeline for transforming object vertices in object space to object vertices in screen space;

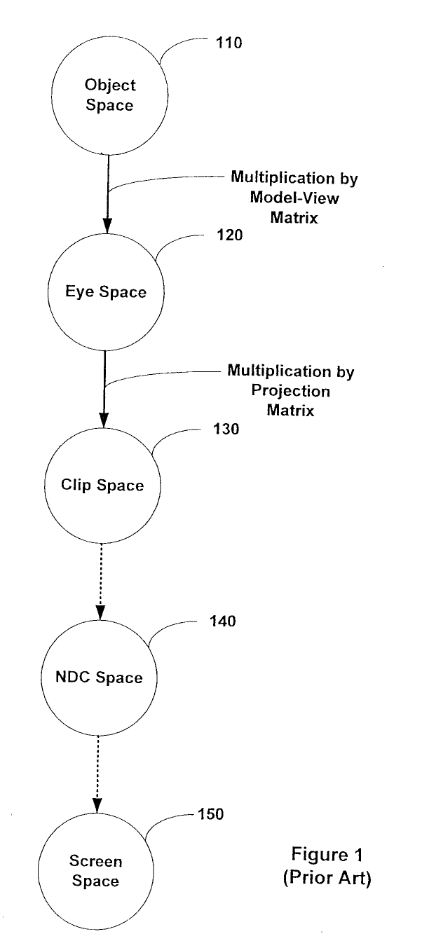

FIG. 2 is a block diagram of an OpenGL rasterization engine for transforming object vertices during rendering of graphical objects for display; and

FIG. 3 is a flowchart showing the steps performed by the rasterization engine of FIG. 2 during object vertex transformation.

### DETAILED DESCRIPTION OF THE EMBODIMENT

In the following description, a method and rasterization engine for transforming object vertices during rendering of graphical objects for display is provided. During the method, each object vertex in object space that is to be transformed, is multiplied by a product matrix. The product matrix is the product of a model-view matrix and a projection matrix. As a result, each object vertex is transformed from object space to clip space via a single multiplication operation. In the event that the product matrix is not to be used, object vertices in object space are transformed to object vertices in clip space in a conventional manner. That is, the object vertices in object space are multiplied by the model-view matrix to transform the object vertices to eye space and the object vertices in eye space are multiplied by a projection matrix to transform the object vertices to clip space.

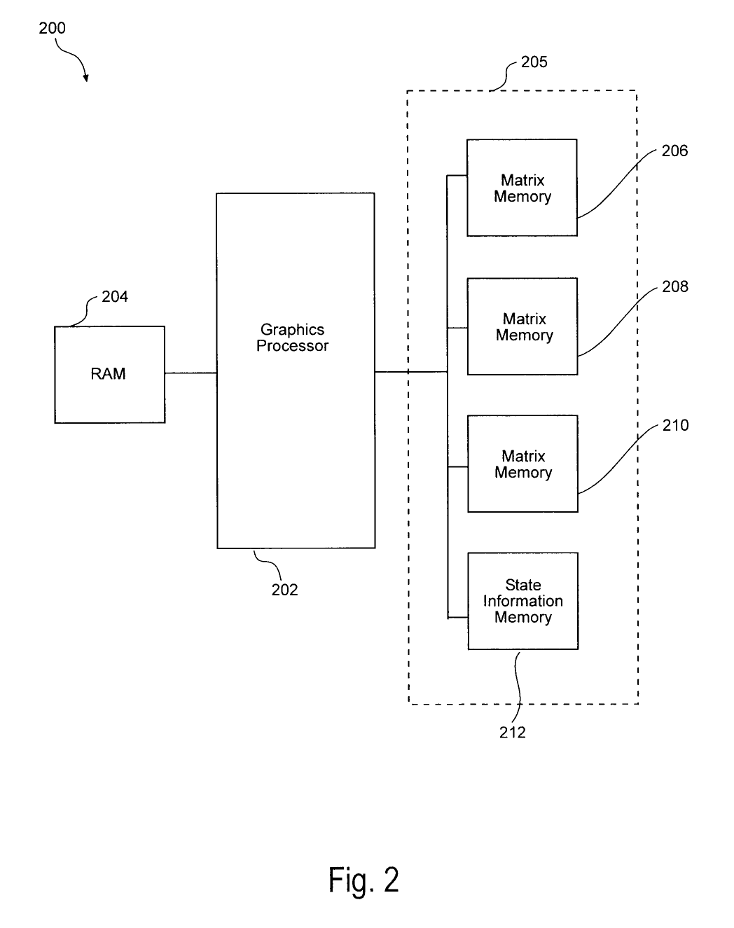

Turning now to FIG. 2, a rasterization engine for transforming object vertices from object space to clip space is shown and is generally identified by reference numeral 200. As can be seen, rasterization engine 200 comprises a graphics processor 202 executing an object vertex transformation application, random access memory 204 and a non-volatile memory array 205 comprising matrix memories 206, 208 and 210, and state information memory 212. Matrix memory 206 stores a model-view matrix [Mₘᵥ] that is used to transform object vertices in object space to object vertices in eye space. Matrix memory 208 stores a projection matrix [Mₚ] that is used to transform object vertices in eye space to object vertices in clip space. Matrix memory 210 stores a product matrix [Mᵥ] that is the result of the product of the model-view and projection matrices [Mₘᵥ] and [Mₚ] respectively. State information memory 212 stores flags that are examined by the graphics processor 202 to determine which matrix or matrices are to be used during object vertex transformation from object space to clip space.

During graphics data processing, hundreds if not thousands of object vertices require transformation from object space to clip space in-between changes to either the model-view matrix [Mₘᵥ] or the projection matrix [Mₚ]. As mentioned previously, processing the object vertices according to Equations (1) and (2) above transforms the object vertices from object space to clip space. Combining Equations (1) and (2) yields:

{V_{c}}=[Mₚ]*([Mₘᵥ]*{Vₒ}) (3)

Equation (3) can be rewritten as:

{V_{c}}=([Mₚ]*[Mₘᵥ])*{Vₒ}

or

{V_{c}}=[Mₓ]*{Vₒ} (4)

where:

{Vₒ} is the object vertex in object space;

{V_{c}} is the object vertex in clip space; and

[Mₓ] is the product matrix resulting from the product of the projection matrix [Mₚ] and the model-view matrix [Mₘᵥ].

Thus, with the product matrix [Mₓ] available, object vertices in object space can be transformed to object vertices in clip space by performing only one matrix multiplication operation, that is by multiplying the object vertices in object space by the product matrix [Mₓ]. As rasterization engine 200 stores the product matrix [Mₓ] in matrix memory 210, object vertex transformations from object space to clip space can be quickly and readily generated.

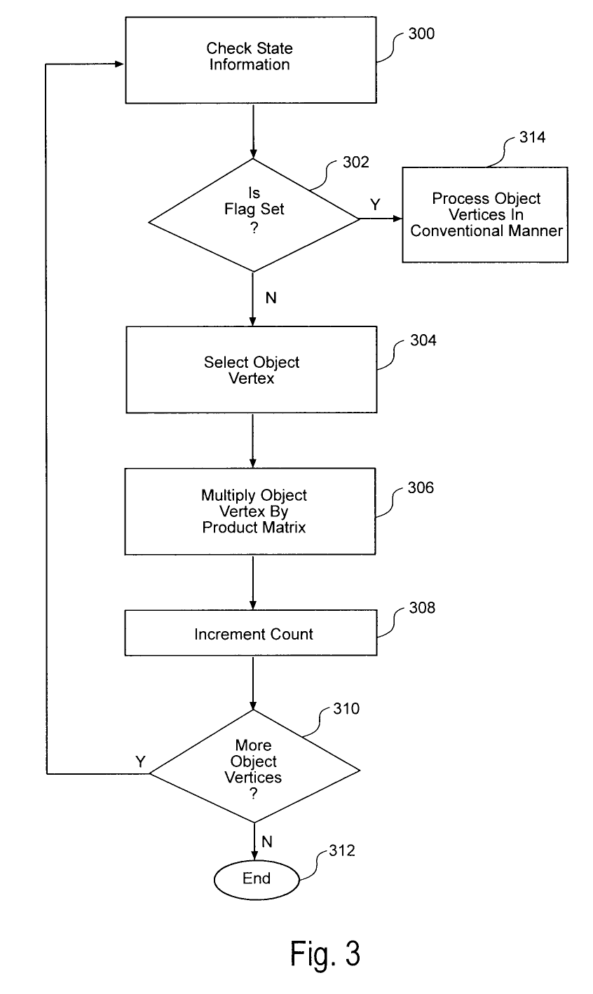

Turning now to FIG. 3, the steps performed by the rasterization engine 200 during object vertex transformation from object space to clip space is shown. For the purpose of this discussion, it is assumed that the product matrix [Mₚ] has been stored in matrix memory 210 and has been loaded into the RAM 204 by the graphics processor 202. When the graphics processor 202 receives the object vertices in object space representing the graphical object to be rendered, the state information memory 212 is checked to determine if one or more flags therein have been set signifying that the product matrix [Mₚ] should not be used to transform object vertices in object space to object vertices in clip space (steps 300 and 302). If no such flags have been set, the graphics processor 202 selects an object vertex (step 304) and multiplies the selected object vertex by the product matrix [Mₚ] thereby to transform the selected object vertex to clip space in one matrix multiplication operation (step 306). An object vertex count is then incremented (step 308) and a check is made to determine if more object vertices for selection exist (step 310). If no additional object vertices for selection exist, the object vertex transformation process is deemed to have been completed (step 312). At step 310, if one or more additional object vertices for selection exist, the process reverts back to step 300. As will be appreciated, if no flags in the state information memory 212 have been set, each object vertex in object space is transformed to an object vertex in clip space via a single multiplication operation.

The state information memory 212 is examined before the product matrix [Mₓ] is used as situations may arise where the product matrix is stale and/or where object vertices in eye space are required. In the latter instance, when certain features of the rasterization engine 200 are enabled, such as for example, OpenGL user clip planes, OpenGL lighting effects or OpenGL fog effects, object vertices in eye space are required. The graphics processor 202 monitors the status of these OpenGL features and when one or more of these features is enabled, the graphics processor 202 sets a corresponding flag in the state information memory 212 for each enabled feature. When such a flag is set, the set flag is detected at step 300 resulting in the product matrix [Mₓ] not being during object vertex transformation.

In this case, the object vertices are transformed from object space to clip space in the conventional manner (step 314). Thus, the graphics processor 202 loads the model-view matrix [Mₘᵥ] and the projection matrix [Mₚ] into the RAM 204. For each object vertex in object space, the graphics processor 202 multiples the object vertex by the model-view matrix [Mₘᵥ] to transform the object vertex to eye space. The graphics processor 202 then multiples each object vertex in eye space by the projection matrix [Mₚ] to transform the object vertex to clip space.

The graphics processor 202 also monitors the status of the model-view and projection matrices [Mₘᵥ] and [Mₚ] to determine whether either or both of these matrices have changed. Changes to these matrices may occur as a result of manual loading of updated model-view and/or projection matrices into the rasterization engine 200, scale, translation or rotation transform operations, popping of the current matrix stack and/or changing of view position or frustum. If any changes to the model-view or projection matrices have occurred, the graphics processor 202 sets corresponding flags in the state information memory 212. When such a flag is set, the set flag is detected at step 300 resulting in the product matrix [Mₓ] not being during object vertex transformation. When changes to the model-view and/or projection matrix have been made, once the current object vertex transformation task has been completed, the graphics processor 202 loads the updated model-view matrix [Mₘᵥ] and projection matrix [Mₚ] into the RAM 204, recalculates the product matrix [Mₓ] and stores the new product matrix [Mₓ] in the matrix memory 210 for future use.

Although not described, once the object vertices have been transformed to clip space, the object vertices can be transformed by the graphics processor 202 to NDC space and then to screen space in the conventional manner.

The rasterization engine 200 may be embodied in the central processing unit (CPU) of a personal computer (PC) or the like or may be embodied in a separate graphical processing unit installed in a personal computer or the like.

The object vertex transformation software application includes computer executable instructions executed by a processing unit such as a graphics processor. The software application may comprise program modules including routines, programs, object components, data structures etc. and be embodied as computer-readable program code stored on a computer-readable medium. The computer-readable medium is any data storage device that can store data, which can thereafter be read by a computer system. Examples of computer-readable medium include for example read-only memory, flash memory, random-access memory, hard disk drives, magnetic tape, CD-ROMs and other optical data storage devices. The computer-readable program code can also be distributed over a network including coupled computer systems so that the computer-readable program code is stored and executed in a distributed fashion.

Although an embodiment has been described, those of skill in the art will appreciate that variations and modifications may be made without departing from the spirit and scope thereof as defined by the appended claims.

What is claimed is:

1. A method of transforming object vertices during rendering of graphical objects for display comprising:
multiplying each object vertex in object space that is to be transformed, by a product matrix, said product matrix being the product of a model-view matrix and a projection matrix thereby to transform each object vertex from object space to clip space via a single multiplication operation.

2. The method of claim 1 further comprising:
prior to said multiplying, checking state information to determine if said state information signifies that said product matrix is not to be used;
if the product matrix is to be used, performing said multiplying; and
if the product matrix is not to be used, multiplying each object vertex in object space by said model-view matrix to transform each object vertex to eye space and multiplying each object vertex in eye space by said projection matrix to transform each object vertex to clip space.

3. The method of claim 2 wherein at least one flag is set if said product matrix is not to be used.

4. The method of claim 3 wherein said at least one flag is set when at least one of said model-view and projection matrices has been changed.

5. The method of claim 4 further comprising:
recalculating the product matrix when at least one of said model-view and projection matrices has been changed.

6. The method of claim 3 wherein said at least one flag is set when at least one selected rasterization feature is enabled.

7. The method of claim 6 wherein said at least one selected rasterization feature is selected from the group consisting of lighting effects, fog effects, and clip planes.

8. The method of claim 5 wherein said at least one flag is set when at least one selected rasterization feature is enabled.

9. The method of claim 6 wherein said at least one selected rasterization feature is selected from the group consisting of lighting effects, fog effects, and clip planes.

10. A computer readable medium embodying a computer program for transforming object vertices during rendering of graphical objects for display, said computer program comprising:
computer program code for multiplying each object vertex in object space that is to be transformed, by a product matrix, said product matrix being the product of a model-view matrix and a projection matrix thereby to transform each object vertex from object space to clip space via a single multiplication operation.

11. The computer-readable medium according to claim 10, wherein said computer program further comprises:
computer program code for checking state information to determine if said state information signifies that said product matrix is not to be used prior to said multiplying; and
computer program code, responsive to said computer program code for checking when said product matrix is not to be used, for multiplying each object vertex in object space by said model-view matrix to transform each object vertex to eye space and for multiplying each object vertex in eye space by said projection matrix to transform each object vertex to clip space when said product matrix is not to be used.

12. A rasterization engine transforming object vertices during rendering of graphical objects for display comprising:
matrix memory storing a model-view matrix, a projection matrix and a product matrix, said product matrix being the product of said model-view and projection matrices;
state information memory; and
a graphics processor multiplying each object vertex by said product matrix to transform each object vertex from object space to clip space in a single multiplication operation.

13. A rasterization engine according to claim 12 wherein said state information memory stores at least one settable flag, said graphics processor multiplying each object vertex by said model-view matrix to transform each object vertex to eye space and multiplying each object vertex in eye space by said projection matrix to transform each object vertex to clip space when a flag in said state information memory is set.

14. A rasterization engine according to claim 13 wherein said at least one flag is set when at least one of said model-view and projection matrices has been changed.

15. A rasterization engine according to claim 14 wherein said at least one flag is set when a selected feature of said rasterization engine is enabled.

16. A rasterization engine according to claim 15 wherein said selected feature is selected from the group consisting of lighting effects, fog effects, and clip planes.

17. A rasterization engine according to claim 14 wherein said graphics processor recalculates the product matrix when one or both of the model-view and projection matrices has been changed.

18. A rasterization engine according to claim 13 wherein said at least one flag is set when a selected feature of said rasterization engine is enabled.

19. A rasterization engine according to claim 18 wherein said selected feature is selected from the group consisting of lighting effects, fog effects, and clip planes.
